(19) United States
(12) Patent Application Publication
(10) Pub. No.: US 2021/0011709 A1
(43) Pub. Date: Jan. 14, 2021

(54) PROGRAM UPDATE SYSTEM, PROGRAM UPDATE METHOD, AND COMPUTER PROGRAM

(71) Applicants: AutoNetworks Technologies, Ltd., Yokkaichi-shi , Mie (JP); Sumitomo Wiring Systems, Ltd., Yokkaichi-shi , Mie (JP); Sumitomo Electric Industries, Ltd., Osaka-shi, Osaka (JP)

(72) Inventor: Taro Itatsu, Yokkaichi-shi, Mie (JP)

(21) Appl. No.: 17/040,828

(22) PCT Filed: Mar. 6, 2019
(86) PCT No.: PCT/JP2019/008781

§ 371 Date: Sep. 23, 2020

(30) Foreign Application Priority Data
Mar. 23, 2018 (JP) 2018-056896

(51) Int. Cl. G06F 8/65; H04L 29/08

(52) U.S. Cl. CPC G06F 8/65; H04L 67/12; H04L 67/34

(57) ABSTRACT

A program update system includes an in-vehicle communication apparatus connected to an in-vehicle control apparatus including a control program for controlling an operation of equipment mounted in a vehicle, and a mobile device that can communicate with the in-vehicle communication apparatus, and transmits, to the in-vehicle communication apparatus, update data for the control program obtained from an external server, the control program being updated as a result of the in-vehicle communication apparatus transmitting, to the in-vehicle control apparatus, the update data received from the mobile device. The in-vehicle communication apparatus includes an obtaining unit that obtains update information indicating an update state of the control program, and an in-vehicle transmission unit that transmits the obtained update information to the mobile device. The mobile device receives the update information transmitted from the in-vehicle transmission unit and transmits the received update information to the external server.

### CROSS-REFERENCE TO RELATED APPLICATIONS

This application is the U.S. national stage of PCT/JP2019/008781 filed on Mar. 6, 2019, which claims priority of Japanese Patent Application No. JP 2018-056896 filed on Mar. 23, 2018, the contents of which are incorporated herein.

### TECHNICAL FIELD

The present disclosure relates to a program update system, a program update method, and a computer program.

### BACKGROUND

In recent years, in the field of automobiles, functions of vehicles have been advancing increasingly, and a large variety of types of equipment are mounted in a vehicle, along with a plurality of so-called ECUs (electronic control units), which are control apparatuses for controlling such equipment. Various ECUs such as vehicle-body ECUs for controlling on/off of intra-vehicle illumination and headlights, sounding of alarms, and the like in response to a switch operation made by a passenger, meter ECUs for controlling operations of meters and the like arranged near the driver's seat, and navigation ECUs for controlling a car navigation apparatus and the like are mounted in a vehicle.

In general, an ECU is constituted by an arithmetic processing apparatus such as a microcomputer, which reads and executes a control program stored in a ROM (read only memory) so as to realize control of equipment. The control program may be different, even for the same vehicle type, depending on the mounted functions and the location where the vehicle is operated, and it is necessary to rewrite the control program in accordance with the mounted functions and location, as well as to rewrite a control program of an old version with the control program of a new version in accordance with version upgrades of the control program.

JP 05-195859A discloses a vehicle control apparatus mounted in a vehicle that rewrites data stored in a non-volatile memory with data received through wireless communication, if the received data could be confirmed as being data transmitted to the vehicle control apparatus.

However, there is a problem in that, if communication between the vehicle control apparatus and a server apparatus is disabled at the timing when update of a control program is complete, the server apparatus cannot be aware of the update state of the control program in the vehicle control apparatus.

The present disclosure has been made in light of such an issue, and aims to provide a program update system, a program update method, and a computer program that make it possible to be aware of the update state of a control program in an in-vehicle control apparatus.

### SUMMARY

A program update system according to one aspect of the present application includes an in-vehicle communication apparatus connected to an in-vehicle control apparatus including a control program for controlling an operation of equipment mounted in a vehicle, and a mobile device that can communicate with the in-vehicle communication apparatus, and transmits, to the in-vehicle communication apparatus, update data for the control program obtained from an external server, the control program being updated as a result of the in-vehicle communication apparatus transmitting, to the in-vehicle control apparatus, the update data received from the mobile device, the in-vehicle communication apparatus includes an obtaining unit configured to obtain update information indicating an update state of the control program and an in-vehicle transmission unit configured to transmit the obtained update information to the mobile device, and the mobile device includes a receiving unit configured to receive the update information transmitted from the in-vehicle transmission unit, and a mobile device transmission unit configured to transmit the received update information to the external server.

In a program update method according to another aspect of the present application, a computer that is able to communicate with an in-vehicle control system including a control program for controlling an operation of equipment mounted in a vehicle, and transmits, to the in-vehicle control system, update data for the control program obtained from an external server is used for: obtaining update information indicating an update state of the control program from the in-vehicle control system, and transmitting the obtained update information to the external server.

A computer program according to another aspect of the present application is a program for causing a computer that is able to communicate with an in-vehicle control system including a control program for controlling an operation of equipment mounted in a vehicle, and transmits, to the in-vehicle control system, update data for the control program obtained from an external server, to obtain update information indicating an update state of the control program from the in-vehicle control system, and to transmit the obtained update information to the external server.

### Advantageous Effects of Disclosure

According to the present application, it is possible to be aware of the update state of a control program in an in-vehicle control apparatus.

### BRIEF DESCRIPTION OF DRAWINGS

FIG. 1 is a schematic diagram showing a schematic configuration of a program update system according to an embodiment of the present disclosure.

FIG. 2 is a block diagram illustrating an internal configuration of an in-vehicle control system.

FIG. 3 is a block diagram illustrating an internal configuration of a mobile device.

FIG. 4 is a block diagram illustrating an internal configuration of a server apparatus.

FIG. 5 is a flowchart illustrating a procedure for registering a mobile device that is performed before a control program is updated.

FIG. 6 is a flowchart illustrating a procedure for updating a control program.

### DETAILED DESCRIPTION OF PREFERRED EMBODIMENTS

Embodiments of the present disclosure will be listed below. In addition, at least some portions of the embodiments described below may be suitably combined.

A program update system according to one aspect of the present application includes an in-vehicle communication apparatus connected to an in-vehicle control apparatus including a control program for controlling an operation of equipment mounted in a vehicle, and a mobile device that can communicate with the in-vehicle communication apparatus, and transmits, to the in-vehicle communication apparatus, update data for the control program obtained from an external server, the control program being updated as a result of the in-vehicle communication apparatus transmitting, to the in-vehicle control apparatus, the update data received from the mobile device, the in-vehicle communication apparatus includes an obtaining unit configured to obtain update information indicating an update state of the control program and an in-vehicle transmission unit configured to transmit the obtained update information to the mobile device, and the mobile device includes a receiving unit configured to receive the update information transmitted from the in-vehicle transmission unit, and a mobile device transmission unit configured to transmit the received update information to the external server.

In the above aspect, the update information indicating the update state of the control program in the in-vehicle control apparatus is obtained, and the obtained update information is transmitted to the external server via the mobile device. As a result, the external server can be always be aware of the update state of the control program installed in the in-vehicle control apparatus, and, when new update data is registered, can notify the user of the presence of the new update data.

In the program update system according to another aspect of the present application, the mobile device includes a detection unit configured to detect a state of communication connection with the in-vehicle communication apparatus, and a transmission control unit configured to suspend or resume transmission of update data to the in-vehicle communication apparatus depending on the detected communication connection state.

In the above aspect, when communication connection between the mobile device and the in-vehicle communication apparatus is disconnected, transmission of the update data to the in-vehicle communication apparatus is suspended, and when the communication connection is recovered, transmission of the update data can be resumed from the point of the suspension.

In the program update system according to another aspect of the present application, the mobile device includes a receiving unit configured to receive a selection for enabling or disabling update of the control program, based on the update data, and, when a selection for enabling update of the control program is received, information regarding a time when the selection was received is transmitted from the mobile device transmission unit to the external server.

In the above aspect, if the user permits update of the control program in the in-vehicle control apparatus, the external server is notified of information regarding the time of the permission, and thus the external server can manage the update permission time of the control program.

In the program update system according to another aspect of the present application, the update information includes information regarding a time when update of the control program was started, whether or not update of the control program was successful, or a version of the updated control program.

In the above aspect, the external server can manage a time when update of the control program was started, whether or not update of the control program was successful, or information regarding the version of the updated control program.

In a program update method according to another aspect of the present application, a computer that is able to communicate with an in-vehicle control system including a control program for controlling an operation of equipment mounted in a vehicle, and transmits, to the in-vehicle control system, update data for the control program obtained from an external server is used for performing processing for obtaining update information indicating an update state of the control program from the in-vehicle control system, and transmitting the obtained update information to the external server.

In the above aspect, the update information indicating the update state of the control program in the in-vehicle control system is obtained, and the update information is notified to the external server. As a result, the external server can always be aware of the update state of the control program installed in the in-vehicle control system, and, if new update data is registered, can notify the user of the presence of the new update data.

A computer program according to another aspect of the present application is a computer program for causing a computer that is able to communicate with an in-vehicle control system including a control program for controlling an operation of equipment mounted in a vehicle, and transmits, to the in-vehicle control system, update data for the control program obtained from an external server, to obtain update information indicating an update state of the control program from the in-vehicle control system, and to transmit the obtained update information to the external server.

In the above aspect, the update information indicating the update state of the control program in the in-vehicle control system is obtained, and the update information is notified to the external server. As a result, the external server can always be aware of the update state of the control program installed in the in-vehicle control system, and, if new update data is registered, can notify the user of the presence of the new update data.

The present disclosure will be described below in detail with reference to the drawings that illustrate embodiments thereof.

### First Embodiment

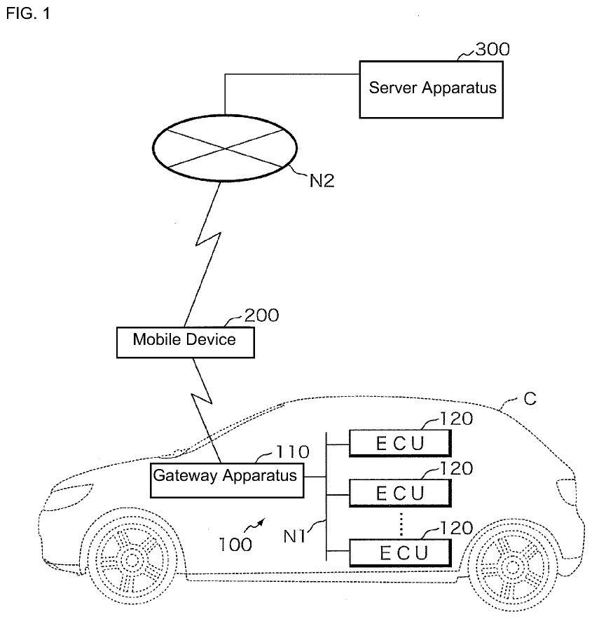

FIG. 1 is a schematic diagram showing a schematic configuration of a program update system according to this embodiment. The program update system according to this embodiment includes an in-vehicle control system 100 mounted in a vehicle C, a mobile device 200 that is carried by the user, and a server apparatus 300 that provides update data for a control program that is used in the in-vehicle control system 100.

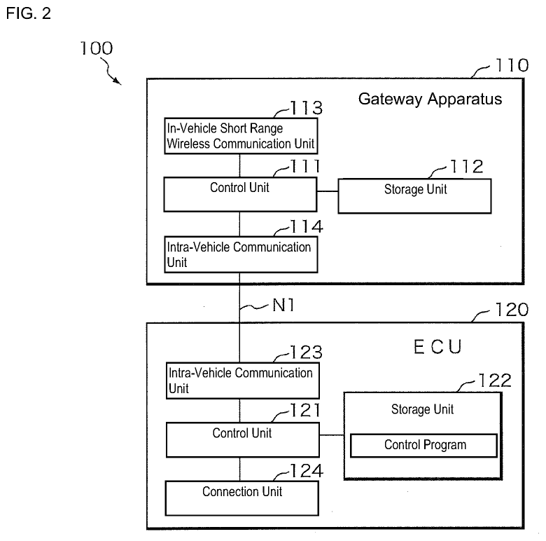

The in-vehicle control system 100 includes a gateway apparatus 110, and a plurality of ECUs 120 connected to the gateway apparatus 110 via an intra-vehicle communication line N1. An ECU 120 includes a storage unit 122 (see FIG. 2) that stores a control program for controlling operations of equipment mounted in the vehicle C. Each ECU 120 controls operations of equipment connected thereto by reading out a control program from the storage unit 122 and executing the control program. The gateway apparatus 110 has a function of communicating with the ECUs 120 via the intra-vehicle communication line N1, and a function of performing short range wireless communication with the mobile device 200.

The mobile device 200 is a computer apparatus that has a communication function, such as a mobile phone, a smartphone, a tablet terminal, or a laptop PC (personal computer). A configuration may be adopted in which the mobile device 200 performs short range wireless communication with the gateway apparatus 110 of the in-vehicle control system 100, and can be connected to a broad-band communication network N2 such as a public phone network or the Internet so as to be able to communicate with the server apparatus 300 via the broad-band communication network N2.

When update data of a control program that is used in an ECU 120 is registered in the server apparatus 300, the server apparatus 300 transmits a notice indicating that there is update data (an update-data-available notice), to the mobile device 200 via the broad-band communication network N2. Upon receiving the update-data-available notice, the mobile device 200 transmits a request to transmit the update data, to the server apparatus 300 in response to a user's instruction. The mobile device 200 holds the update data transmitted from the server apparatus 300 in response to the transmission request, and transfers the update data to the in-vehicle control system 100 at a timing when communication with the in-vehicle control system 100 is enabled, so as to execute update of the control program used in the ECU 120.

Internal configurations of the in-vehicle control system 100, the mobile device 200, and the server apparatus 300 will be described below.

FIG. 2 is a block diagram illustrating an internal configuration of the in-vehicle control system 100. The gateway apparatus 110 of the in-vehicle control system 100 includes a control unit 111, a storage unit 112, an in-vehicle short range wireless communication unit 113, and an intra-vehicle communication unit 114, for example.

The control unit 111 includes a CPU (central processing unit), a ROM (read only memory), a RAM (random access memory), and the like. The CPU in the control unit 111 controls operations of the above-mentioned hardware units of the gateway apparatus 110 by executing a program stored in the ROM or the storage unit 112, and causes the gateway apparatus 110 to function as an in-vehicle communication apparatus of the present application. The RAM in the control unit 111 temporarily stores various types of data generated when a program is being executed.

Note that the control unit 111 is not limited to the above-described configuration, and the control unit 111 may be one or more processing circuits that include a single-core CPU, a multi-core CPU, a microcomputer, a volatile or non-volatile memory, and the like. In addition, the control unit 111 may also have functions of a clock that outputs time-and-date information, a timer that measures a time that elapsed from when a measurement start instruction was given until when a measurement end instruction was given, a counter that counts, and the like.

The storage unit 112 includes a non-volatile memory such as an EEPROM (electronically erasable programmable read only memory). The storage unit 112 stores programs that are executed by the control unit 111, data required for executing the programs, and the like.

The in-vehicle short range wireless communication unit 113 includes a communication interface for performing short range wireless communication with the mobile device 200. The in-vehicle short range wireless communication unit 113 performs wireless communication with the mobile device 200 using a wireless transmission method conforming to a communication standard such as Bluetooth (registered trademark), WiFi (registered trademark), ZigBee (registered trademark), or another wireless LAN (local area network). Note that the in-vehicle short range wireless communication unit 113 may use an appropriate wireless transmission method in consideration of the wireless reachable distance, the transmission band, and the like, and use of a plurality of wireless transmission methods may be switched according to a state.

The intra-vehicle communication unit 114 includes a communication interface for communicating with the ECUs 120 via the intra-vehicle communication line N1. The intra-vehicle communication unit 114 communicates with the ECUs 120 using communication methods conforming to various communication standards that are used in in-vehicle networks such as CAN (controller area network), LIN (local interconnect network), MOST (media oriented systems transport), or Ethernet (registered trademark).

An ECU 120 of the in-vehicle control system 100 includes a control unit 121, the storage unit 122, an intra-vehicle communication unit 123, a connection unit 124, and the like. Note that FIG. 2 shows only one ECU 120, but the other ECUs 120 have a configuration similar to that of the ECU 120 shown in FIG. 2.

The control unit 121 includes a CPU, a ROM, a RAM, and the like. The CPU in the control unit 121 controls operations of the above-mentioned hardware units of the ECU 120 by executing a program stored in the ROM or the storage unit 122, and causes the ECU 120 to function as an in-vehicle control apparatus in accordance with the present application. The RAM in the control unit 121 temporarily stores various types of data generated when a program is being executed.

Note that the control unit 121 is not limited to the above-described configuration, and the control unit 121 may be one or more processing circuits that include a single-core CPU, a multi-core CPU, a microcomputer, a volatile or non-volatile memory, and the like. In addition, the control unit 121 may also have functions of a clock that outputs time-and-date information, a timer that measures a time that elapsed from when a measurement start instruction was given until when a measurement end instruction was given, a counter that counts, and the like.

The storage unit 122 includes a non-volatile memory such as an EEPROM. The storage unit 122 stores programs that are executed by the control unit 121, data required for executing the programs, and the like.

The programs that are stored in the storage unit 122 include a control program for controlling operations of equipment mounted in the vehicle C. A configuration is adopted in which this control program is updated using update data provided from the server apparatus 300 as appropriate. Note that the control program may also be updated as a result of some modules, data, or the like being rewritten, or may also be updated by being entirely replaced with a new control program.

The intra-vehicle communication unit 123 includes a communication interface for communicating with the gateway apparatus 110 via the intra-vehicle communication line N1. The intra-vehicle communication unit 123 communicates with the gateway apparatus 110 using a communication method conforming to one of various communication standards used in in-vehicle networks such as CAN, LIN, MOST, and Ethernet (registered trademark).

The connection unit 124 includes an interface for connection to equipment mounted in the vehicle C. Examples of the equipment that is connected to the connection unit 124 include a drive control apparatus that performs drive control of an engine or a battery system that is a driving source of the vehicle C, a door locking mechanism for locking/unlocking vehicle doors, lighting devices inside/outside the vehicle, and devices such as an air conditioner. The control unit 121 of the ECU 120 controls operations of the equipment connected to the connection unit 124, by outputting a control signal from the connection unit 124.

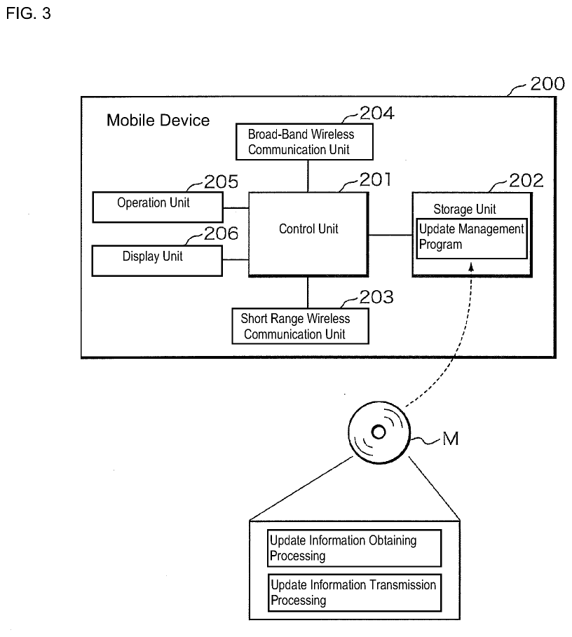

FIG. 3 is a block diagram illustrating an internal configuration of the mobile device 200. The mobile device 200 is a terminal apparatus such as a smartphone or a personal computer, and includes a control unit 201, a storage unit 202, a short range wireless communication unit 203, a broad-band wireless communication unit 204, an operation unit 205, a display unit 206, and the like.

The control unit 201 includes a CPU, a ROM, a RAM, and the like. The ROM of the control unit 201 stores a control program for controlling operations of the above-mentioned hardware units, and the like. The CPU in the control unit 201 executes the control program stored in the ROM and various programs stored in the storage unit 202 to be described later so as to control operations of the above-mentioned hardware units. Note that the RAM of the control unit 201 stores data that is temporarily used when various programs are executed.

Note that the control unit 201 is not limited to the above-described configuration, and the control unit 201 may be one or more processing circuits that include a single-core CPU, a multi-core CPU, a microcomputer, a volatile or non-volatile memory, and the like. In addition, the control unit 201 may have functions of a clock that outputs time-and-date information, a timer that measures a time that elapsed from when a measurement start instruction was given until when a measurement end instruction was given, a counter that counts, and the like.

The storage unit 202 includes a storage device that uses an EEPROM, a flash memory, a hard disk, and the like. The storage unit 202 stores various computer programs that are executed by the control unit 201, various types of data that are used for these computer programs, various types of data obtained through communication, authentication data required for mutual authentication that is executed with the in-vehicle control system 100, and the like.

The computer programs stored in the storage unit 202 include an update management program for managing the update state of a control program in an ECU 120. The control unit 201 realizes an update management method according to this embodiment by executing the update management program.

Note that a program stored in the storage unit 202 may also be provided by a recording medium M in which the program is recorded in a readable manner. The recording medium M is a field-portable memory such as a CD-ROM, a USB memory, an SD card, a micro SD card, or a compact flash (registered trademark). The control unit 201 can read various programs from the recording medium M using a reading apparatus (not illustrated), and can install the read various programs in the storage unit 202. In addition, a program stored in the storage unit 202 may also be provided through communication via the broad-band wireless communication unit 204. In this case, the control unit 201 can obtain various programs through the broad-band wireless communication unit 204, and install the obtained various program in the storage unit 202.

The short range wireless communication unit 203 includes a communication interface for performing short range wireless communication with the gateway apparatus 110. The short range wireless communication unit 203 performs wireless communication with the gateway apparatus 110 using a wireless transmission method conforming to a communication standard of Bluetooth (registered trademark), ZigBee (registered trademark), another wireless LAN, or the like. Note that the short range wireless communication unit 203 may use an appropriate wireless transmission method in consideration of the wireless reachable distance, the transmission band, and the like, and use of a plurality of wireless transmission methods may be switched according to a state.

The broad-band wireless communication unit 204 includes a communication interface for connection to the broad-band communication network N2 such as a public phone network or the Internet, transmits various types of information to be notified to the outside, and receives various types of information transmitted from the outside.

The operation unit 205 includes input interfaces such as a touch panel and operation buttons, and receives various types of operation information and setting information. The control unit 201 performs appropriate control based on operation information input from the operation unit 205, and stores setting information in the storage unit 202 as necessary.

The display unit 206 includes a display device such as a liquid crystal display panel or an organic EL display panel, and displays information to be notified to the user of the mobile device 200 (for example, a passenger of the vehicle C), based on a control signal output from the control unit 201.

Note that, in this embodiment, a configuration is adopted in which short range wireless communication is performed between the in-vehicle control system 100 (the gateway apparatus 110) and the mobile device 200, but there is no limitation to short range wireless communication necessarily, and a configuration may also be adopted in which intermediate distance or long distance wireless communication is performed. In addition, a configuration may also be adopted in which wired communication is performed between the gateway apparatus 110 and the mobile device 200.

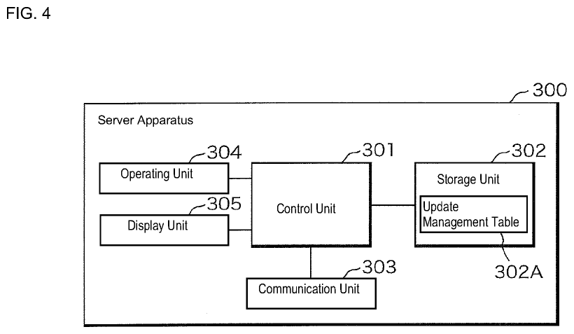

FIG. 4 is a block diagram illustrating an internal configuration of the server apparatus 300. The server apparatus 300 is a central processing apparatus constituted by a computer, and includes a control unit 301, a storage unit 302, a communication unit 303, an operating unit 304, a display unit 305, and the like.

The control unit 301 includes a CPU, a ROM, a RAM, and the like. The ROM of the control unit 301 stores a control program for controlling operations of the above-mentioned hardware units, and the like. The CPU in the control unit 301 executes a control program stored in the ROM and various programs stored in the storage unit 302 to be described later, so as to control operations of the above-mentioned hardware units. Note that the RAM of the control unit 301 stores data that is temporarily used when various programs are executed.

Note that the control unit 301 is not limited to the above-described configuration, and the control unit 301 may be one or more processing circuits that include a single-core CPU, a multi-core CPU, a microcomputer, a volatile or non-volatile memory, and the like. In addition, the control unit 301 may have functions of a clock that outputs time-and-date information, a timer that measures a time that elapsed from when a measurement start instruction was given until when a measurement end instruction was given, a counter that counts, and the like.

The storage unit 302 includes a storage device that uses an EEPROM, a flash memory, a hard disk, and the like. The storage unit 302 stores various computer programs that are executed by the control unit 301, various types of data that are used for these computer programs, various types of data obtained through communication, and the like. In addition, the storage unit 302 includes an update management table 302A for managing the update state of a control program in each ECU 120.

The communication unit 303 includes a communication interface for connection to the broad-band communication network N2 such as a public phone network or the Internet, transmits various types of information to be notified to the outside, and receives various types of information transmitted from the outside.

The operating unit 304 includes input interfaces such as a touch panel and operation buttons, and receives various types of operation information and setting information. The control unit 301 performs appropriate control based on operation information that is input from the operating unit 304, and, stores setting information in the storage unit 302 as necessary.

The display unit 305 includes a display device of a liquid crystal display panel, an organic EL display panel, or the like, and displays information to be notified to the administrator of the server apparatus 300 or the like, based on a control signal output from the control unit 301.

A procedure for updating a control program installed in the ECU 120 will be described below.

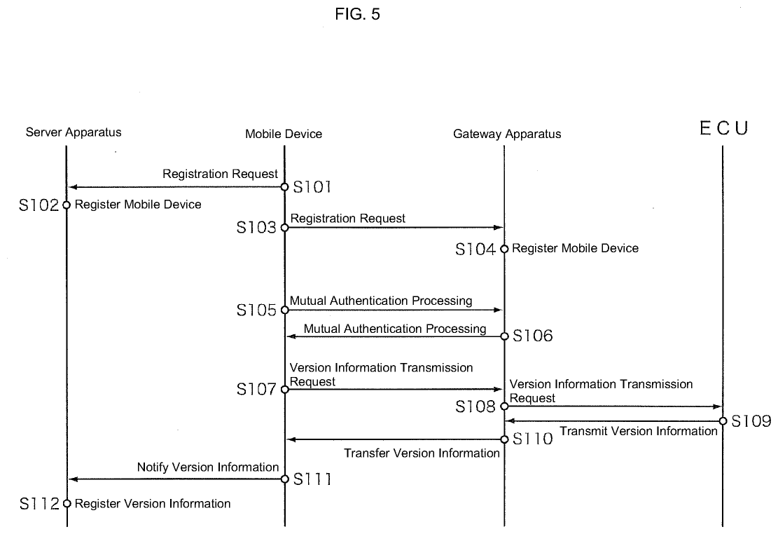

FIG. 5 is a flowchart illustrating a procedure for registering the mobile device 200 that is performed before update of a control program. When updating a control program of the ECU 120 using the mobile device 200, information regarding the mobile device 200 is registered in both the server apparatus 300 and the gateway apparatus 110. Note that processing for registering the mobile device 200 needs to be performed only once, and it is not necessary to perform the processing every time the control program is updated.

When an operation of instructing a request for registration to the server apparatus 300 is received by the operation unit 205, the mobile device 200 transmits a registration request, to which its identification information is added, to the server apparatus 300 through the broad-band wireless communication unit 204 (step S101).

The server apparatus 300 receives the registration request transmitted from the mobile device 200, through the communication unit 303. Upon receiving the registration request, the control unit 301 registers, in the update management table 302A, the identification information of the mobile device 200 added to the registration request (step S102).

When an operation of instructing a request for registration to the gateway apparatus 110 is received though the operation unit 205, the mobile device 200 transmits a registration request to which its identification information is added, to the gateway apparatus through the short range wireless communication unit 203 (step S103). At this time, the mobile device 200 obtains identification information for identifying the gateway apparatus 110, to which the mobile device 200 is to be registered, and stores the obtained identification information in the storage unit 202.

The gateway apparatus 110 receives the registration request transmitted from the mobile device 200, through the in-vehicle short range wireless communication unit 113. Upon receiving the registration request, the control unit 301 registers, in the storage unit 112, the identification information of the mobile device 200 added to the registration request (step S104).

Note that, in this embodiment, a configuration is adopted in which registration in the server apparatus 300 is performed first, and then registration in the gateway apparatus 110 is then performed, but, of course, registration in the server apparatus 300 may also be performed after registration in the gateway apparatus 110 is performed. In addition, a configuration may also be performed in which, when a registration request is given to one of the server apparatus 300 and the gateway apparatus 110, a registration request is automatically given to the other.

Next, mutual authentication processing is performed between the mobile device 200 and the gateway apparatus 110 (steps S105 and S106). At this time, the control unit 201 of the mobile device 200 transmits the identification information of the mobile device 200, which is stored in the storage unit 202, to the gateway apparatus 110 through the short range wireless communication unit 203, and causes the gateway apparatus 110 to determine the validity of the identification information. Also, the control unit 201 obtains identification information of the gateway apparatus 110, and determines the validity of the obtained identification information.

If the mutual authentication processing is successful, the control unit 201 of the mobile device 200 requests for the version information of the control program installed in the ECU 120 (step S107). At this time, the control unit 201 transmits a request to transmit the version information, to the gateway apparatus 110 through the short range wireless communication unit 203. Note that, if the mutual authentication processing fails, the control unit 201 of the mobile device 200 ends the processing of this flowchart without executing the process in step S107 onward.

The gateway apparatus 110 receives, through the in-vehicle short range wireless communication unit 113, the request to transmit the version information transmitted from the mobile device 200. Upon receiving the request to transmit the version information, the control unit 111 transfers the received request to transmit the version information, to the ECU 120 (step S108).

The ECU 120 receives, through the intra-vehicle communication unit 123, the request to transmit the version information transferred from the gateway apparatus 110. Upon receiving the request to transmit the version information, the control unit 121 reads out the version information of the control program from the storage unit 122, and transmits the read version information to the gateway apparatus 110 through the intra-vehicle communication unit 123 (step S109). Note that identification information for identifying the ECU 120 may be added to the version information that is transmitted from the ECU 120 to the gateway apparatus 110.

The gateway apparatus 110 receives the version information transmitted from the ECU 120, through the intra-vehicle communication unit 114. Upon receiving the version information, the control unit 111 transfers the received version information to the mobile device 200 through the in-vehicle short range wireless communication unit 113 (step S110). That is to say, the control unit 111 of the gateway apparatus 110 (in-vehicle communication apparatus) functions as an obtaining unit that obtains update information indicating the update state of the control program. Also, the in-vehicle short range wireless communication unit 113 functions as an in-vehicle transmission unit that transmits the obtained update information to the mobile device 200.

The mobile device 200 receives the version information of the control program to be updated, which is installed in the ECU 120, through the short range wireless communication unit 203. Upon receiving the version information, the control unit 201 notifies the server apparatus 300 of the received version information, through the broad-band wireless communication unit 204 (step S111). That is to say, the short range wireless communication unit 203 of the mobile device 200 functions as a receiving unit that receives update information transmitted from the in-vehicle short range wireless communication unit 113 (in-vehicle communication unit). Also, the broad-band wireless communication unit 204 functions as a mobile device transmission unit that transmits the received update information to the server apparatus 300 (external server).

The server apparatus 300 receives the version information notified by the mobile device 200, through the communication unit 303. Upon receiving the notification of the version information, the control unit 301 registers the received version information in the update management table 302A in association with the identification information of the mobile device 200 (step S112). In addition, if the identification information of the ECU 120 is added to the received version information, the identification information of the ECU 120 may also be registered along with the version information.

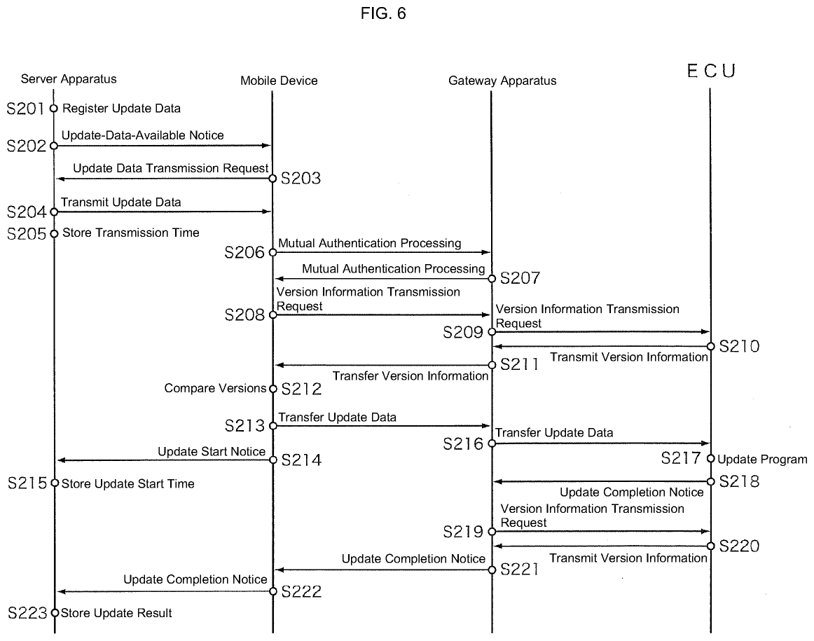

FIG. 6 is a flowchart illustrating a procedure for updating the control program. When update data for the control program installed in the ECU 120 is created, and the update data is registered in the storage unit 302 of the server apparatus 300 (step S201), the control unit 301 compares the update data with version information registered in the update management table 302A, and determines whether or not to notify the mobile device 200 of the availability of new update data. If update data that rewrites the control program to a newer version than the version registered in the update management table 302A is registered, the control unit 301 transmits an update-data-available notice to the mobile device 200 through the communication unit 303 to notify the mobile device 200 that there is update data (step S202).

The mobile device 200 receives the update-data-available notice transmitted from the server apparatus 300, through the broad-band wireless communication unit 204. Upon receiving the update-data-available notice, the control unit 201 transmits a request to transmit the update data, to the server apparatus 300 through the broad-band wireless communication unit 204 (step S203). A configuration may also be adopted in which, at this time, the control unit 201 displays, on the display unit 206, a check screen for checking whether or not to permit update of the control program, and only when an instruction indicating that update is permitted is received by the operation unit 205, a request to transmit the update data is transmitted to the server apparatus 300. That is to say, the operation unit 205 of the mobile device 200 may also function as a receiving unit that receives a selection for enabling or disabling update of the control program. In addition, if the instruction indicating that update is permitted is received, the control unit 201 may notify the server apparatus 300 of information regarding the time when the user permitted update, through the broad-band wireless communication unit 204.

The server apparatus 300 receives, through the communication unit 303, the request to transmit the update data, which has been transmitted from the mobile device 200. Upon receiving the request to transmit the update data, the control unit 301 reads out the update data from the storage unit 302, and transmits the read update data to the mobile device 200 through the communication unit 303 (step S204). In addition, when the update data is transmitted to the mobile device 200, the control unit 301 stores the time of the transmission in the update management table 302A (step S205). Note that, when transmitting the update data, the control unit 301 may notify the mobile device 200 of an estimated time required for updating (rewriting) the control program, an estimated time required for resetting the updated control program, and the like.

The mobile device 200 receives the update data transmitted from the server apparatus 300, through the broad-band wireless communication unit 204. When the update data is received, the user that carries the mobile device 200 may be inside or outside the vehicle C. Upon receiving the update data, the control unit 201 stores the received update data in the storage unit 202. If, thereafter, short range wireless communication is enabled between the mobile device 200 and the gateway apparatus 110 (when a passenger that carries the mobile device 200 enters the vehicle C, or approaches the vehicle C), mutual authentication processing is performed between the mobile device 200 and the gateway apparatus 110 of the vehicle C (steps S206 and S207). At this time, the control unit 201 of the mobile device 200 transmits the identification information of the mobile device 200 stored in the storage unit 202 to the gateway apparatus 110 through the short range wireless communication unit 203, and causes the gateway apparatus 110 to determine the validity of the identification information. In addition, the control unit 201 obtains identification information of the gateway apparatus 110 from the gateway apparatus 110, and determines the validity of the obtained identification information.

If the mutual authentication processing is successful, the control unit 201 of the mobile device 200 requests the version information of the control program installed in the ECU 120 (step S208). At this time, the control unit 201 transmits a request to transmit the version information, to the gateway apparatus 110 through the short range wireless communication unit 203. Note that, if the mutual authentication processing fails, the control unit 201 of the mobile device 200 ends the processing of this flowchart without executing the process in step S208 onward.

The gateway apparatus 110 receives the request to transmit the version information, which has been transmitted from the mobile device 200, through the in-vehicle short range wireless communication unit 113. Upon receiving the request to transmit the version information, the control unit 111 transfers the received request to transmit the version information, to the ECU 120, for which update is to be performed (step S209).

The ECU 120, for which update is to be performed, receives the request to transmit the version information transferred from the gateway apparatus 110, through the intra-vehicle communication unit 123. Upon receiving the request to transmit the version information, the control unit 121 reads out the version information of the control program from the storage unit 122, and transmits the read version information to the gateway apparatus 110 through the intra-vehicle communication unit 123 (step S210).

The gateway apparatus 110 receives the version information transmitted from the ECU 120, through the intra-vehicle communication unit 114. Upon receiving the version information, the control unit 111 transfers the received version information to the mobile device 200 through the in-vehicle short range wireless communication unit 113 (step S211).

The mobile device 200 receives, through the short range wireless communication unit 203, the version information of the control program installed in the ECU 120, which is to be updated. Upon receiving the version information, the control unit 201 compares the version information of the update data stored in the storage unit 202 with the received version information (step S212). As a result of the comparison, if it is determined that the version of the control program that is to be rewritten with the update data is newer than the version indicated by the received version information (i.e. the version of control program installed in the ECU 120), the control unit 201 transfers the update data to the gateway apparatus 110 through the short range wireless communication unit 203 (step S213).

When the update data is being transferred, the control unit 201 detects the state of the communication connection in short range wireless communication with the gateway apparatus 110 at an appropriate time interval. If communication disconnection is detected, the control unit 201 may suspend transfer of the update data. In addition, a configuration may also be adopted in which the control unit 201 stores a suspension point in the storage unit 202, and, when communication connection is recovered, resumes transfer of the update data from the suspension point. That is to say, the control unit 201 functions as a detection unit that detects the state of communication connection to the gateway apparatus 110 (in-vehicle communication apparatus), and also functions as a transmission control unit that suspends or resumes transmission of the update data according to a communication connection state.

When transfer of the control program is started, the control unit 201 transmits an update start notice indicating that update of the control program has been started, to the server apparatus 300 through the broad-band wireless communication unit 204 (step S214). The update start notice may include information regarding a time when transfer of the update data was started (or a time when rewriting of the control program was started).

The server apparatus 300 receives the update start notice transmitted from the mobile device 200, through the communication unit 303. Upon receiving the update start notice, the control unit 301 stores the update start time in the update management table 302A (step S215).

The gateway apparatus 110 receives the update data transmitted from the mobile device 200, through the in-vehicle short range wireless communication unit 113. Upon receiving the update data, the control unit 111 transfers the received update data to ECU 120 that is to be updated (step S216).

Note that, when the update data is transmitted from the gateway apparatus 110 to the ECU 120, the control program is rewritten in the ECU 120, and thus the gateway apparatus 110 may determine whether or not a timing when the control program may be rewritten has arrived, before transmitting the update data. If a control program that does not pose any obstacle if rewritten while the vehicle C is running is to be rewritten, for example, the control unit 111 may transmit update data to the ECU 120 irrespective of whether or not the vehicle C is running. On the other hand, if a control program that poses an obstacle on running control if rewritten while the vehicle C is running is to be rewritten, the control unit 111 may transmit update data to the ECU 120 after the ignition is turned off, for example.

The ECU 120 receives the update data transferred from the gateway apparatus 110, through the intra-vehicle communication unit 123. Upon receiving the update data, the control unit 121 updates the control program stored in the storage unit 122 (step S217). At this time, the control unit 121 updates the control program by rewriting a portion or the entirety of the control program stored in the storage unit 122, based on the update data. When update of the control program is complete, the control unit 121 transmits an update completion notice to the gateway apparatus 110 through the intra-vehicle communication unit 123 (step S218). The update completion notice may include information regarding a time when update was complete.

The gateway apparatus 110 receives the update completion notice transmitted from the ECU 120, through the intra-vehicle communication unit 114. Upon receiving the update completion notice, the control unit 111 transmits a request to transmit the version information, to the ECU 120 through the intra-vehicle communication unit 114 (step S219).

The ECU 120 receives the request to transmit the version information transmitted from the gateway apparatus 110, through the intra-vehicle communication unit 123. Upon receiving the request to transmit the version information, the control unit 121 reads out the version information of the control program from the storage unit 122, and transmits the read version information to the gateway apparatus 110 through the intra-vehicle communication unit 123 (step S220). As a result of this processing, the gateway apparatus 110 is notified of the version of the updated control program.

Note that, in this embodiment, a configuration is adopted in which a request to transmit version information is transmitted from the gateway apparatus 110 that has received an update completion notice, to the ECU 120, but a configuration may also be adopted in which version information is notified along with an update completion notice. In this case, the processes in steps S219 and S220 are not necessary. In addition, upon receiving the update completion notice, a reset request may be given from the gateway apparatus 110 to the ECU 120 in order to restart the updated control program.

The gateway apparatus 110 receives the version information transmitted from the ECU 120, through the intra-vehicle communication unit 114. Upon receiving the version information, the control unit 111 transmits an update completion notice to which the version information is added, to the mobile device 200 through the in-vehicle short range wireless communication unit 113 (step S221).

The mobile device 200 receives the update completion notice transmitted from the gateway apparatus 110, through the short range wireless communication unit 203. Upon receiving the update completion notice, the control unit 201 transfers the update completion notice to the server apparatus 300 through the broad-band wireless communication unit 204 (step S222). In addition, upon receiving the update completion notice, the control unit 201 may erase update data stored in the storage unit 202.

The server apparatus 300 receives the update completion notice transferred from the mobile device 200, through the communication unit 303. Upon receiving the update completion notice, the control unit 301 stores the update result in the update management table 302A (step S223). At this time, the control unit 301 may store, in the update management table 302A, a message indicating that update of the control program in the ECU 120 was successful, the version of the updated control program, an update completion time, and the like. The control unit 301 also counts, using a timer incorporated therein, a time that has elapsed from when the update data was transmitted in step S204, and if it is determined that a set time has elapsed without receiving an update completion notice, an message indicating that update failed may be stored in the update management table 302A.

As described above, in this embodiment, when update data for rewriting the control program of the ECU 120 is registered in the server apparatus 300, the update data can be downloaded to the mobile device 200 irrespective of whether or not the user that carries the mobile device 200 is in the vehicle C. Then, the control program of the ECU 120 can be updated as a result of transferring update data from the mobile device 200 at the timing when communication between the mobile device 200 and the in-vehicle control system 100 is enabled.

In addition, the mobile device 200 can obtain information regarding the update state of the control program in the ECU 120, and notify the server apparatus 300 of the information regarding the update state. As a result, the server apparatus 300 can always be aware of the version of the control program installed in the ECU 120, and, when new update data is registered, can notify the user of the presence of the new update data through the mobile device 200.

The disclosed embodiments are to be considered as illustrative and non-limiting in all aspects. The scope of the present disclosure is indicated not by the above-stated meanings but by the scope of claims, and is intended to include all modifications that are within the meanings and the scope that are equivalent to those of the scope of claims.

1. A program update system that includes:
an in-vehicle communication apparatus connected to an in-vehicle control apparatus including a control program for controlling an operation of equipment mounted in a vehicle, and
a mobile device that can communicate with the in-vehicle communication apparatus, and transmits, to the in-vehicle communication apparatus, update data for the control program obtained from an external server, the control program being updated as a result of the in-vehicle communication apparatus transmitting, to the in-vehicle control apparatus, the update data received from the mobile device,
wherein the in-vehicle communication apparatus includes:
an obtaining unit configured to obtain update information indicating an update state of the control program, and
an in-vehicle transmission unit configured to transmit the obtained update information to the mobile device, and
the mobile device includes:
a receiving unit configured to receive the update information transmitted from the in-vehicle transmission unit, and
a mobile device transmission unit configured to transmit the received update information to the external server.

2. The program update system according to claim 1,
wherein the mobile device includes:
a detection unit configured to detect a state of communication connection with the in-vehicle communication apparatus, and
a transmission control unit configured to suspend or resume transmission of update data to the in-vehicle communication apparatus depending on the detected communication connection state.

3. The program update system according to claim 1,
wherein the mobile device includes:
a receiving unit configured to receive a selection for enabling or disabling update of the control program, based on the update data, and
when a selection for enabling update of the control program is received, information regarding a time when the selection was received is transmitted from the mobile device transmission unit to the external server.

4. The program update system according claim 1, wherein the update information includes information regarding a time when update of the control program was started, whether or not update of the control program was successful, or a version of the updated control program.

5. A program update method,
wherein a computer that is able to communicate with an in-vehicle control system including a control program for controlling an operation of equipment mounted in a vehicle, and transmits, to the in-vehicle control system, update data for the control program obtained from an external server is used for performing processing for:
obtaining update information indicating an update state of the control program from the in-vehicle control system, and
transmitting the obtained update information to the external server.

6. A computer program for causing a computer that is able to communicate with an in-vehicle control system including a control program for controlling an operation of equipment mounted in a vehicle, and transmits, to the in-vehicle control system, update data for the control program obtained from an external server, to obtain update information indicating an update state of the control program from the in-vehicle control system, and to transmit the obtained update information to the external server.

7. The program update system according to claim 2,
wherein the mobile device includes:
a receiving unit configured to receive a selection for enabling or disabling update of the control program, based on the update data, and
when a selection for enabling update of the control program is received, information regarding a time when the selection was received is transmitted from the mobile device transmission unit to the external server.

8. The program update system according claim 2, wherein the update information includes information regarding a time when update of the control program was started, whether or not update of the control program was successful, or a version of the updated control program.

9. The program update system according claim 3, wherein the update information includes information regarding a time when update of the control program was started, whether or not update of the control program was successful, or a version of the updated control program.
